(19) United States
(12) Patent Application Publication
(10) Pub. No.: US 2011/0053629 A1
(43) Pub. Date: Mar. 3, 2011

(54) BASE STATION APPARATUS, ANTENNA DEVICE, TERMINAL DEVICE, COMMUNICATION SYSTEM, AND COMMUNICATION METHOD

(75) Inventor: Hiroyuki SEKI, Kawasaki (JP)

(73) Assignee: FUJITSU LIMITED, Kawasaki-shi (JP)

(21) Appl. No.: 12/873,296

(22) Filed: Aug. 31, 2010

(30) Foreign Application Priority Data
Sep. 1, 2009 (JP) 2009-201520

(51) Int. Cl. H04B 7/00

(52) U.S. Cl. 455/509

(57) ABSTRACT

A base station apparatus that communicates with a terminal device includes an acquiring unit that acquires propagation quality between the base station apparatus and the terminal device and propagation quality between the base station apparatus and an antenna device provided forward of the terminal device; and a scheduler unit that allocates wireless resources for communication with the terminal device, based on the propagation qualities acquired by the acquiring unit.

### CROSS-REFERENCE TO RELATED APPLICATIONS

This application is based upon and claims the benefit of priority from the prior Japanese Patent Application No. 2009-201520, filed on Sep. 1, 2009, the entire contents of which are incorporated herein by reference.

### FIELD

The embodiments discussed herein are related to a base station apparatus, an antenna device, a terminal device, a communication system, and a communication method that perform wireless communication.

### BACKGROUND

In cellular mobile communication in which a base station communicates with a terminal, the base station determines the state of the uplink propagation path by using a reference signal sent from the terminal. The base station collects information indicative of the state of downlink propagation paths for each terminal by receiving downlink propagation path information measured and fed back by the terminal. The base station has a scheduling function of allocating uplink and downlink wireless resources based on such information.

During the cellular mobile communication, the propagation path state fluctuates drastically and communication quality changes significantly with the movement of the terminal. In particular, when the terminal is hidden behind an obstacle such as a building or when the terminal enters a tunnel, the propagation path state deteriorates significantly and consequently, the transmission speed is reduced or the communication is suspended. Therefore, a technology is under study that forecasts fluctuations caused by shadowing, such as by a building or entrance into the tunnel, and sets the communication method according to the forecast fluctuations.

For example, a technology has been disclosed that forecasts time transition of radio wave blocking, based on electronic map data or destination information possessed by a mobile object and performs scheduling, etc., according to results of the forecast (see, e.g., Japanese Laid-Open Patent Publication No. 2003-188802). A technology has been disclosed that measures field strength using an antenna provided at a forward aspect of the mobile object and performs communication using an antenna provided at a rear aspect of the mobile object, based on results of the measurement (see, e.g., Japanese Laid-Open Patent Publication No. H7-154856).

The conventional technologies, however, have a problem of being incapable of accurately forecasting fluctuations in the propagation quality at the terminal on the mobile object and incapable of enhancing the quality of communication between the base station and the mobile terminal. For example, the invention described in Japanese Laid-Open Patent Publication No. 2003-188802 has a problem in that use of electronic map data to forecast the radio wave blocking state involves processing an enormous amount of data and does not necessarily guarantee the accuracy of the forecast. The invention described in Japanese Laid-Open Patent Publication No. H7-154856 has a problem of being incapable of forecasting the fluctuation of the propagation quality at the mobile terminal in the mobile object and incapable of enhancing the quality of communication between the base station and the mobile terminal.

### SUMMARY

According to an aspect of an embodiment, a base station apparatus that communicates with a terminal device includes an acquiring unit that acquires propagation quality between the base station apparatus and the terminal device and propagation quality between the base station apparatus and an antenna device provided forward of the terminal device; and a scheduler unit that allocates wireless resources for communication with the terminal device, based on the propagation qualities acquired by the acquiring unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting a configuration of a communication system according to a first embodiment.

FIG. 2 is a sequence diagram of one example of operation of the communication system according to the first embodiment.

FIG. 3 is a flowchart of one example of scheduling operation of a base station apparatus according to the first embodiment.

FIG. 4 is a diagram depicting one example of a configuration of an antenna device according to the first embodiment.

FIG. 5 is a diagram depicting one example of the base station apparatus according to the first embodiment.

FIG. 6 is a diagram depicting a configuration of a terminal device according to the first embodiment.

FIG. 7 is a sequence diagram of one example of operation of the communication system according to the second embodiment.

FIG. 8 is a diagram depicting one example of a configuration of the antenna device according to the second embodiment.

FIG. 9 is a diagram depicting one example of a configuration of the base station apparatus according to the second embodiment.

FIG. 10 is a diagram depicting one example of a configuration of the base station apparatus according to a third embodiment.

### DESCRIPTION OF EMBODIMENTS

Preferred embodiments of the present invention will be explained with reference to the accompanying drawings.

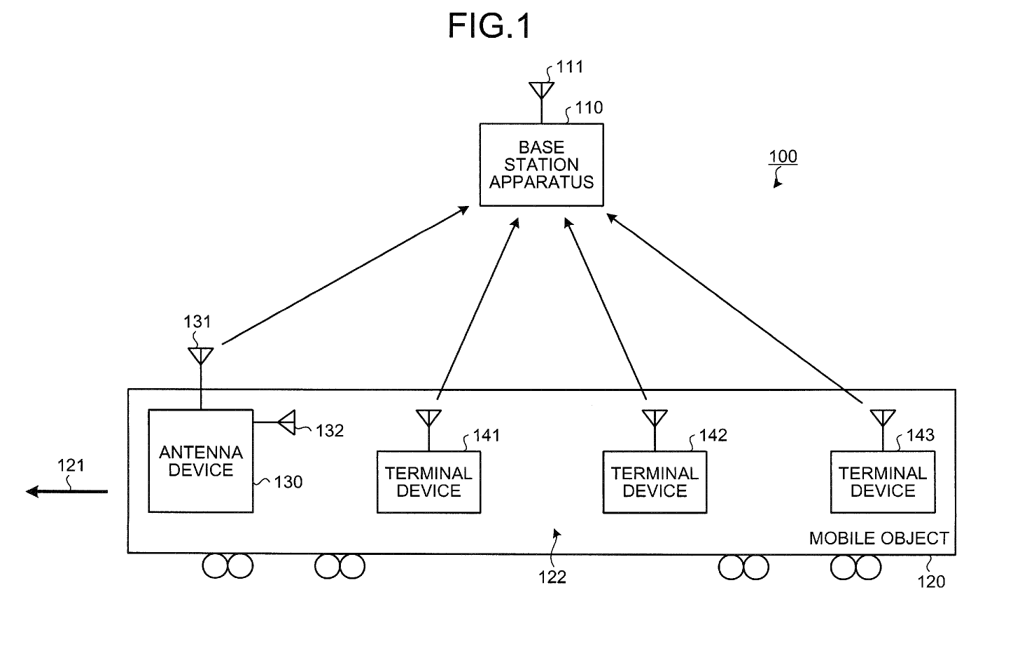

FIG. 1 depicts a configuration of a communication system according to a first embodiment. As depicted in FIG. 1, a communication system 100 includes a base station apparatus 110, a mobile object 120, an antenna device 130, and terminal devices 141 to 143. The base station apparatus 110 communicates with the terminal devices 141 to 143 in the mobile object 120. The base station apparatus 110 is equipped with an antenna 111 and uses the antenna 111 to wirelessly communicate with the antenna device 130 and the terminal devices 141 to 143.

The mobile object 120 is a mobile object such as a train or a bus. A traveling direction 121 indicates the direction of movement of the mobile object 120. The antenna device 130 is provided forward (with respect to the traveling direction 121) of the terminal devices 141 to 143 in the mobile object 120. The mobile object 120 has an open space 122 capable of accommodating the terminal devices 141 to 143 behind (with respect to the traveling direction 121) the antenna device 130.

The antenna device 130 is equipped with a forecast-use antenna 131 and a terminal-use antenna 132. The antenna device 130 uses the forecast-use antenna to recursively transmit a reference signal to the base station apparatus 110. The antenna device 130 uses the terminal-use antenna 132 to distribute (broadcast) to the open space 122, identification information (e.g., reference number) indicative of the reference signal transmitted from the forecast-use antenna 131.

The terminal devices 141 to 143 are communication terminals capable of mobile communication such as a cellular phone and a portable information terminal. The terminal devices 141 to 143 are located in the open space 122 of the mobile object 120. The terminal devices 141 to 143 receive the identification information distributed from the antenna device 130 and transmit (signal) the received identification information to the base station apparatus 110. Each of the terminal devices 141 to 143 recursively transmits the reference signal to the base station apparatus 110.

The base station apparatus 110 measures the propagation quality (e.g., field strength) between the base station apparatus 110 and the antenna device 130, based on the reference signal transmitted from the antenna device 130. The base station apparatus 110 recognizes that the mobile object 120 carrying the terminal devices 141 to 143 is equipped with the antenna device 130, based on the identification information transmitted from the terminal devices 141 to 143. The base station apparatus 110 identifies the reference signal transmitted from the antenna device 130, among various reference signals transmitted from other sources in the vicinity, based on the identification information transmitted from the terminal devices 141 to 143.

The base station apparatus 110 measures the propagation quality between the base station 110 and the terminal devices 141 to 143 by receiving the reference signals transmitted from the terminal devices 141 to 143. The base station apparatus 110 compares the propagation quality for the antenna device 130 and the propagation quality for the terminal devices 141 to 143 thus measured and performs scheduling of the terminal devices 141 to 143, based on results of the comparison.

The reference signals to be transmitted and received between the base station apparatus 110, antenna device 130, and the terminal devices 141 to 143 are signals multiplexed by time, frequency, or code, etc. With different reference numbers respectively allocated for the antenna device 130 and the terminal devices 141 to 143, the reference signals may be multiplexed for transmission and reception between the base station apparatus 110, the antenna device 130, and the terminal devices 141 to 143.

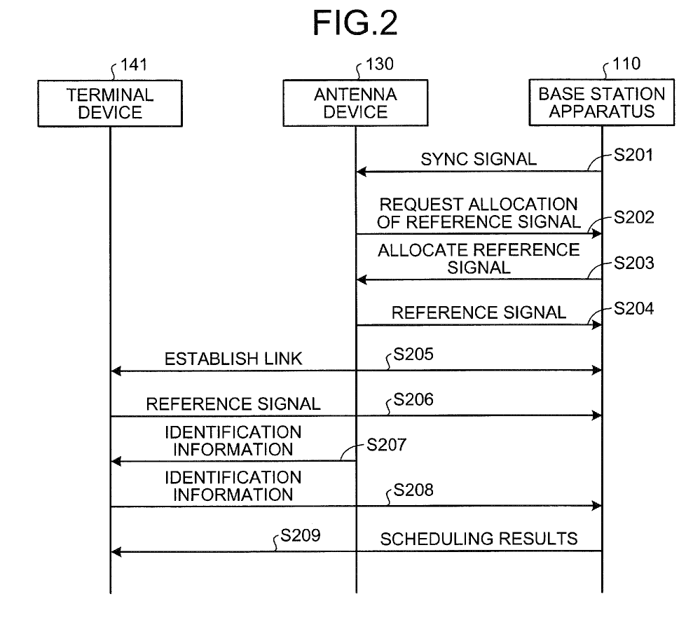

FIG. 2 is a sequence diagram of one example of operation of the communication system according to the first embodiment. Although FIG. 2 describes the operation of the terminal device 141 among the terminal devices 141 to 143, operation of the terminal devices 142 and 143 is substantially identical. Firstly, the base station apparatus 110 transmits a sync signal for the terminal device 141 and the antenna device 130 to synchronize (step S201). The antenna device 130 receiving the sync signal transmitted at step S201, adjusts the timing of reception and transmission and recognizes basic information (cell number, transmission bandwidth, transmission strength, etc.) of the base station apparatus 110.

Then, the antenna device 130 requests the base station apparatus 110 to allocate a reference signal (step S202). The request for allocation of a reference signal at step S202 is made, for example, using an uplink random access channel, etc. Then, in response to the request for allocation at step S202, the base station apparatus 110 allocates a reference signal to the antenna device 130 (step S203).

Subsequently, the antenna device 130 starts transmission of the reference signal allocated at step S203 (step S204). Then, the terminal device 141 establishes a link with the base station apparatus 110 by an initial access or a handover, etc. (step S205). Through the operation at step S205, the terminal device 141 is allocated an uplink reference signal by the base station apparatus 110.

Then, the terminal device 141 starts transmission of the reference signal allocated by the base station apparatus 110 (step S206). Subsequently, the antenna device 130 distributes the identification information of the reference signal that the antenna device 130 has started to transmit at step S204 (step S207). The identification information distributed at step S207 is received by the terminal device 141 located in the open space 122 of the mobile object 120.

Then, the terminal device 141 transmits the identification information distributed at step S207 to the base station apparatus 110 (step S208). The base station apparatus 110 performs scheduling based on the reference signals whose transmission was started at step S204 and step S206 and notifies the terminal device 141 of results of the scheduling (step S209), ending a sequence of operations.

At step S209, by receiving the reference signal indicated by the identification information transmitted at step S208, the base station apparatus 110 receives the reference signal from the antenna device 130. These steps enable the base station apparatus 110 to perform the scheduling (allocation of wireless resources) for the terminal device 141, based on the propagation quality between the base station apparatus 110 and the antenna device 130 and the propagation quality between the base station apparatus 110 and the terminal device 141.

Although an example has been described where the base station apparatus 110 allocates the number of the reference signal to be transmitted by the antenna device 130, the number of the reference signal used by the antenna device 130 may be preliminarily determined, in which case, there is no need for the allocation of the number of the reference signal by the base station apparatus 110.

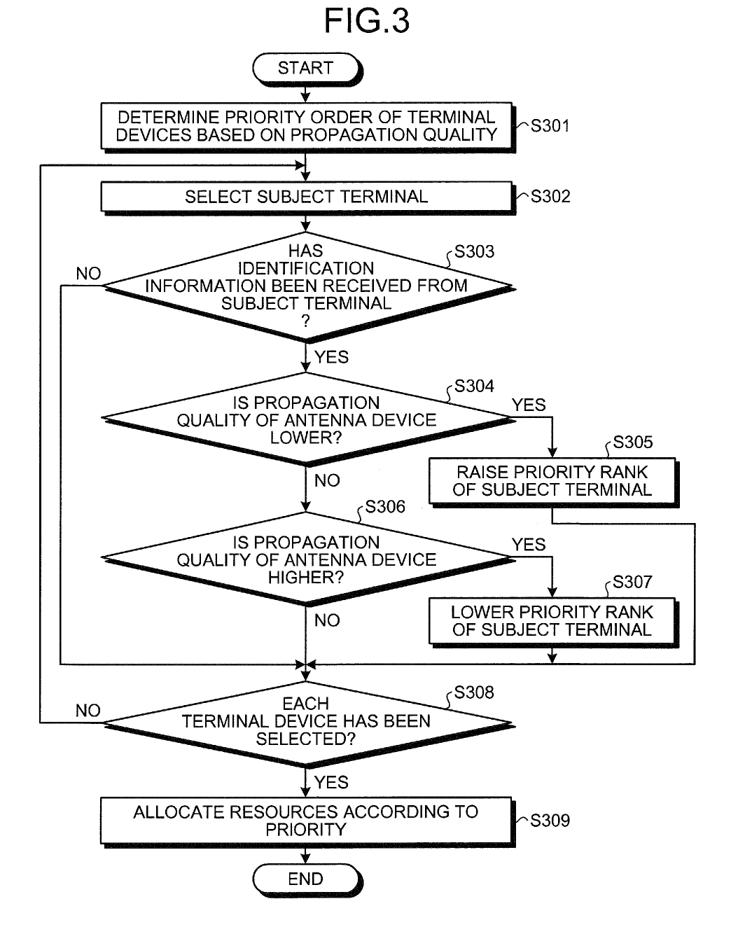

FIG. 3 is a flowchart of one example of scheduling operation of the base station apparatus according to the first embodiment. The base station apparatus 110 firstly measures the propagation quality based on the reference signal received from each terminal device to communicate with the base station apparatus 110 and determines the order of priority of the terminal devices, based on the measured propagation quality (step S301). For example, the base station apparatus 110 may determine that a terminal device of a higher propagation quality will be given a higher priority.

Then, the base station apparatus 110 selects, from among the terminal devices, a subject terminal that is to be subject to priority rank adjustment (step S302). The base station apparatus 110 determines whether the identification information, indicative of the reference signal of the antenna device 130, has been received from the subject terminal selected at step S302 (step S303), whereby the base station apparatus 110 is able to determine whether the subject terminal is located on the mobile object 120 on which the antenna device 130 is provided. If the identification information has not been received from the subject terminal (step S303: NO), then the flow proceeds to step S308, without performing the priority rank adjustment.

At step S303, if the identification information has been received from the subject terminal (step S303: YES), the base station apparatus 110 determines whether the propagation quality for the antenna device 130 is lower than that for the subject terminal (step S304), whereby the base station apparatus 110 is able to determine whether the propagation quality at the subject terminal is deteriorating. If the propagation quality for the antenna device 130 is lower than that for the subject terminal (step S304: YES), the base station apparatus 110 raises the priority rank of the subject terminal (step S305) and the flow proceeds to step S308.

At step S304, if the propagation quality for the antenna device 130 is not lower than that for the subject terminal (step S304: NO), the base station apparatus 110 determines whether the propagation quality for the antenna device 130 is higher than that for the subject terminal (step S306), whereby the base station is able to determine whether the propagation quality at the subject terminal is improving. If the propagation quality for the antenna device 130 is higher than that for the subject terminal (step S306: YES), the base station apparatus 110 lowers the priority rank of the subject terminal (step S307) and the flow proceeds to step S308.

At step S306, if the propagation quality for the antenna device 130 is not higher than that for the subject terminal (step S306: NO), the base station apparatus 110 determines whether each of the terminal devices that is to communicate with the base station apparatus 110 has been selected at step S302 (step S308). If each of the terminal devices has not been selected (step S308: NO), the flow returns to step S302, where the base station apparatus 110 selects a terminal device not yet selected as the subject terminal, from among the remaining terminal devices.

At step S308, if all the terminal devices have been selected (step S308: YES), the base station apparatus 110 allocates the resources to terminal devices in the order of priority (step S309), thereby ending a sequence of scheduling operations. These operations make it possible to raise the priority of a terminal device having a deteriorating propagation quality and to lower the priority of a terminal device having an improving propagation quality, relative to the terminal devices 141 to 143 in the mobile object.

The priority of a terminal device having a deteriorating propagation quality is raised so that wireless resources can be allocated and communication can be performed before the propagation quality deteriorates beyond that enabling communication. The priority of a terminal device having an improving propagation quality is lowered so that wireless resources can be allocated and communication can be performed after improvement of the propagation quality. Thus, the base station apparatus 110 is able to communicate with the terminal devices 141 to 143 under a state of better propagation quality and with improved throughput.

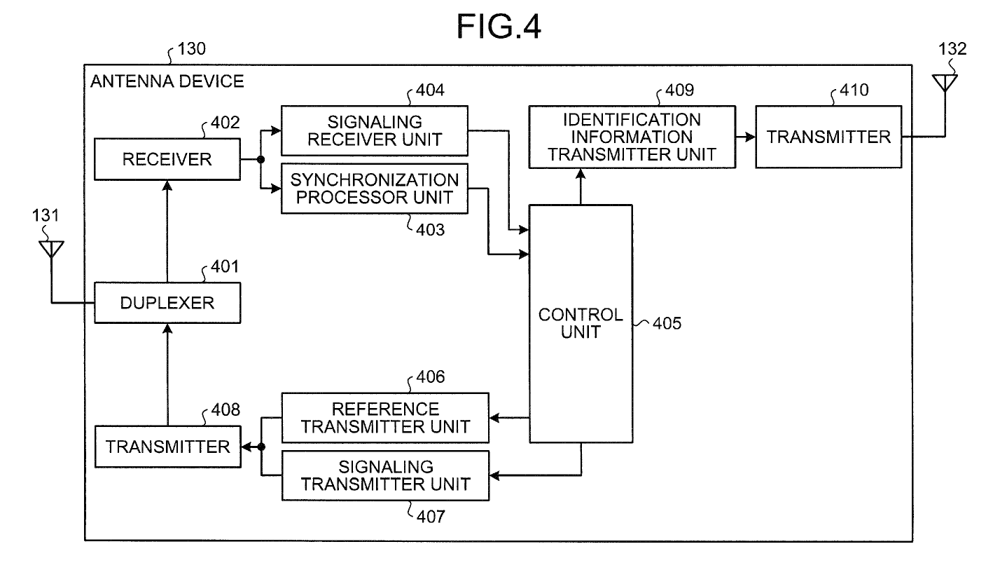

FIG. 4 depicts one example of a configuration of the antenna device according to the first embodiment. In FIG. 4, components identical those depicted in FIG. 1 are given the same reference numerals used in FIG. 1 and description thereof is omitted. As depicted in FIG. 4, the antenna device 130 is equipped with the forecast-use antenna 131, the terminal-use antenna 132, a duplexer 401, a receiver 402, a synchronization processor unit 403, a signaling receiver unit 404, a control unit 405, a reference transmitter unit 406, a signaling transmitter unit 407, a transmitter 408, an identification information transmitter unit 409, and a transmitter 410.

The forecast-use antenna 131 is an antenna for performing the wireless communication with the base station apparatus 110. For example, the forecast-use antenna 131 receives a signal transmitted from the base station apparatus 110 and outputs the received signal to the duplexer 401. The forecast-use antenna 131 outputs to the base station apparatus 110, a signal from the duplexer 401. While the forecast-use antenna 131 is an antenna having functions of a transmitting antenna and a receiving antenna, a transmitting antenna and a receiving antenna may separately be provided in place of the forecast-use antenna 131.

The duplexer 401 outputs to the receiver 402, the signal from the forecast-use antenna 131. Further, the duplexer 401 outputs to the forecast-use antenna 131, the signal from the transmitter 408. If the transmitting antenna and the receiving antenna are separately provided in place of the forecast-use antenna 131, the duplexer 401 may be omitted.

The receiver 402 down-converts the signal (radio-frequency signal (RF)) output from the duplexer 401 to a baseband signal and then converts the baseband signal to a digital signal. The receiver 402 outputs the digital signal to the synchronization processor unit 403 and the signaling receiver unit 404.

The synchronization processor unit 403 receives a sync signal transmitted by the base station apparatus 110, among the signals output from the receiver 402. The synchronization processor unit 403 uses the received sync signal in processing of synchronizing time and frequency and in receiving basic information (cell number, transmission bandwidth, transmission strength, etc.) of the base station apparatus 110 to which connection is made. The synchronization processor unit 403 outputs to the control unit 405, results of the synchronization processing and the basic information of the base station apparatus 110.

The signaling receiver unit 404 receives a signaling signal transmitted by the base station apparatus 110, among the signals output from the receiver 402. The signaling signal includes the number of the reference signal allocated by the base station apparatus 110. The signaling receiver unit 404 outputs to the control unit 405, the number of the reference signal.

The control unit 405 performs communication control of the antenna device 130. For example, the control unit 405 outputs the number of the reference signal output from the signaling receiver unit 404 to the reference transmitter unit 406. The control unit 405 controls the signaling transmitter unit 407 so that the signaling signal to be transmitted to the base station apparatus 110 is generated based on the basic information output from the synchronization processor unit 403. The control unit 405 outputs to the identification information transmitter unit 409, the number of the reference signal output from the signaling receiver unit 404.

The reference transmitter unit 406, the transmitter 408, and the forecast-use antenna 131 make up a transmitter unit that transmits the reference signal to the base station apparatus 110. For example, the reference transmitter unit 406 generates the reference signal to be transmitted to the base station apparatus 110, based on the number of the reference signal output from the control unit 405. The reference transmitter unit 406 outputs the generated reference signal to the transmitter 408.

Under the control of the control unit 405, the signaling transmitter unit 407 generates a signaling signal to be transmitted to the base station apparatus 110. The signaling signal generated by the signaling transmitter unit 407 is, for example, a signal requesting the base station apparatus 110 for an allocation of a reference signal. The signaling transmitter unit 407 outputs the generated signaling signal to the transmitter 408.

The transmitter 408 converts the reference signal output from the reference transmitter unit 406 and the signaling signal output from the signaling transmitter unit 407, to an analog signal. The transmitter 408 up-converts the analog signal (baseband signal) to an RF signal and outputs the RF signal to the duplexer 401.

The identification information transmitter unit 409, the transmitter 410, and the terminal-use antenna 132 make up a distributor unit that distributes the identification information of the reference signal to be transmitted by the antenna device 130. For example, the identification information transmitter unit 409 generates the identification information indicative of the reference signal allocated to the antenna device 130. For example, the identification information transmitter unit 409 generates the identification information inclusive of the number of the reference signal output from the control unit 405. The identification information transmitter unit 409 outputs the generated identification information to the transmitter 410.

The transmitter 410 converts the identification information output from the identification information transmitter unit 409, to an analog signal, up-converts the analog signal (baseband signal) to an RF signal, and outputs the RF signal to the terminal-use antenna 132. The identification information output to the terminal-use antenna 132 from the transmitter 410 is wirelessly distributed to the terminal devices 141 to 143 by the terminal-use antenna 132.

The synchronization processor unit 403, the signaling receiver unit 404, the control unit 405, the reference transmitter unit 406, the signaling transmitter unit 407, and the identification information transmitter unit 409 may be implemented, for example, by an arithmetic device such as a digital signal processor (DSP).

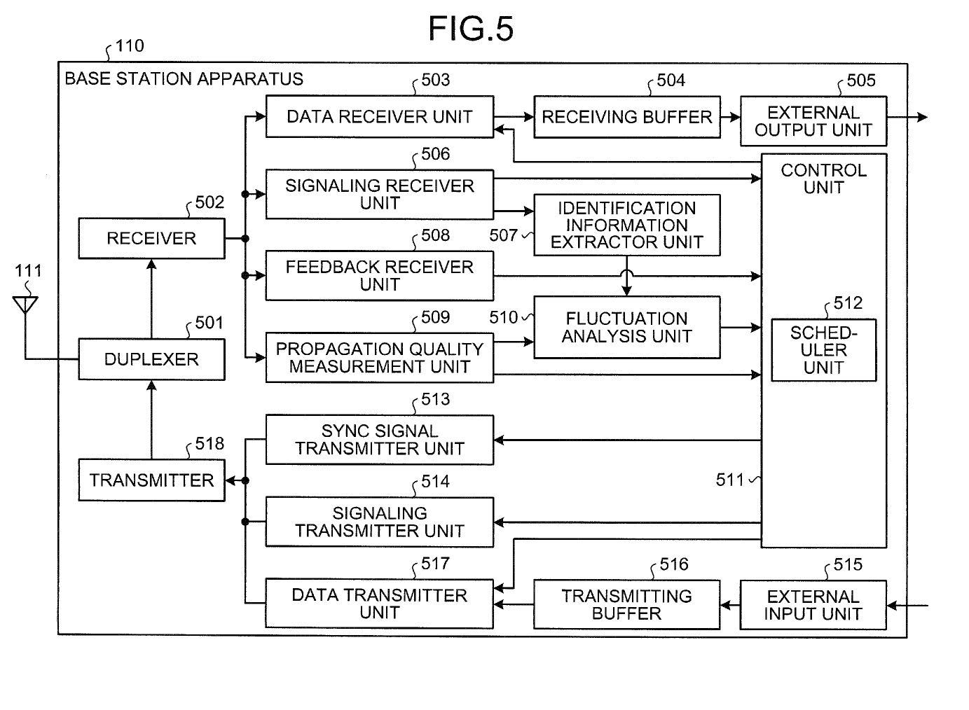

FIG. 5 depicts one example of the base station apparatus according to the first embodiment. As depicted in FIG. 5, the base station apparatus 110 is equipped with the antenna 111, a duplexer 501, a receiver 502, a data receiver unit 503, a receiving buffer 504, an external output unit 505, a signaling receiver unit 506, an identification information extractor unit 507, a feedback receiver unit 508, a propagation quality measurement unit 509, a fluctuation analysis unit 510, a control unit 511, a scheduler unit 512, a synch signal transmitter unit 513, a signaling transmitter unit 514, an external input unit 515, a transmitting buffer 516, a data transmitter unit 517, and a transmitter 518.

The antenna 111 is an antenna that performs the wireless communication with the antenna device 130 and the terminal devices 141 to 143. The antenna 111 receives the signals transmitted from the antenna device 130 and the terminal devices 141 to 143 and outputs the received signals to the duplexer 501. The antenna 111 transmits to the antenna device 130 and the terminal devices 141 to 143, the signal from the duplexer 501. While the antenna 111 is an antenna having functions of a transmitting antenna and a receiving antenna, a transmitting antenna and a receiving antenna may separately be provided in place of the antenna 111.

The duplexer 501 outputs to the receiver 502, the signal from the antenna 111. The duplexer 501 outputs to the antenna 111, the signal from the transmitter 518. If the transmitting antenna and the receiving antenna are separately provided in place of the antenna 111, the duplexer 501 may be omitted.

The receiver 502 down-converts the signal (RF: radio-frequency signal) output from the duplexer 501 to a baseband signal and then converts the baseband signal to a digital signal. The receiver 502 outputs the digital signal to the data receiver unit 503, the signaling receiver unit 506, the feedback receiver unit 508, and the propagation quality measurement unit 509.

Under the control of the control unit 511, the data receiver unit 503 receives data (user data) transmitted by the terminal devices 141 to 143, among the signals output from the receiver 502. The data receiver unit 503 outputs the received data to the receiving buffer 504. The receiving buffer 504 stores the data output from the data receiver unit 503. The external output unit 505 reads out the data stored to the receiving buffer 504 and transmits the data to an external core network.

The signaling receiver unit 506 receives the signaling signal transmitted by the antenna device 130 and the terminal devices 141 to 143, among the signals output from the receiver 502. The signaling signal from the antenna device 130 and the terminal devices 141 to 143 includes a request for allocation of a reference signal. The signaling receiver unit 506 outputs to the control unit 511, the received request for the allocation of a reference signal.

The signaling receiver unit 506 outputs to the identification information extractor unit 507, the signaling signal transmitted by the terminal devices 141 to 143. The identification information extractor unit 507 extracts the identification information included in the signaling signal output from the signaling receiver unit 506 and outputs the extracted identification information to the fluctuation analysis unit 510.

The feedback receiver unit 508 receives downlink feedback information transmitted by the antenna device 130 and the terminal devices 141 to 143, among the signals output from the receiver 502. The feedback information indicates the propagation quality measured by the antenna device 130 and the terminal devices 141 to 143, based on the reference signal from the base station apparatus 110. The feedback receiver unit 508 outputs the received feedback information to the control unit 511.

The propagation quality measurement unit 509 is an acquiring unit that acquires the propagation quality between the base station 110 apparatus and the terminal devices 141 to 143 and the propagation quality between the base station apparatus 110 and the antenna device 130. For example, the propagation quality measurement unit 509 receives the reference signals transmitted by the antenna device 130 and the terminal devices 141 to 143, among the signals output from the receiver 502 and measures uplink propagation quality based on the received reference signals. The propagation quality measurement unit 509 notifies the fluctuation analysis unit 510 and the control unit 511 of the measured propagation quality.

The fluctuation analysis unit 510 is a comparing device that compares the propagation quality for the terminal devices 141 to 143 and the propagation quality for the antenna device 130. For example, the fluctuation analysis unit 510 compares the propagation quality between the antenna device 130 and the base station apparatus 110 and the propagation quality between the base station apparatus 110 and each of the terminal devices 141 to 143 using the propagation quality reported by the propagation quality measurement unit 509.

The fluctuation analysis unit 510 outputs results of the comparison to the control unit 511. The fluctuation analysis unit 510 is capable of identifying the propagation quality between the antenna device 130 and the base station apparatus 110, among the propagation qualities reported by the propagation quality measurement unit 509, based on the identification information output from the identification information extractor unit 507.

The control unit 511 performs the communication control of the base station apparatus 110. For example, the control unit 511 controls the sync signal transmitter unit 513 so as to generate the sync signal. The control unit 511 allocates reference signals (e.g., reference number) to the antenna device 130 and the terminal devices 141 to 143, based on the request for the allocation of a reference signal output from the signaling receiver unit 506. The control unit 511 notifies the signaling transmitter unit 514 of the results of the allocation.

The control unit 511 is equipped with the scheduler unit 512. The scheduler unit 512 performs scheduling of plural communication terminals that communicate with the base station apparatus 110. The communication terminals that communicate with the base station apparatus 110 may include, besides the terminal devices 141 to 143, other terminal devices that are external to the mobile object 120.

For example, the scheduler unit 512 allocates wireless resources to downlink communication with the terminal devices 141 to 143, based on downlink propagation quality indicated by the feedback information output from the feedback receiver unit 508. The scheduler unit 512 further allocates wireless resources to uplink communication with the terminal devices 141 to 143, based on uplink propagation quality reported by the propagation quality measurement unit 509.

The scheduler unit 512 establishes the order of priority for the communication terminals and allocates wireless resources to the communication terminals in descending order of priority. Therefore, a communication terminal with a higher priority as established by the scheduler unit 512 receives allocation of wireless resources to communicate with the base station apparatus 110 before a communication terminal with a relatively lower priority.

The scheduler unit 512 adjusts the priority rank of the terminal devices 141 to 143, based on the comparison results output from the fluctuation analysis unit 510. For example, the scheduler unit 512, treating each of the terminal devices 141 to 143 as a subject terminal, raises the priority rank of a subject terminal if the propagation quality between the base station apparatus 110 and the antenna device 130 is relatively lower than the propagation quality between the base station apparatus 110 and the subject terminal, thereby enhancing the possibility that a subject terminal having a deteriorating propagation quality will be given allocation of the wireless resources before other communication terminals, shortening the period of time before communication is started. Thus, communication with the subject terminal can be performed before the propagation quality for the subject terminal is deteriorated beyond that enabling communication.

The scheduler unit 512, treating each of the terminal devices 141 to 143 as a subject terminal, lowers the priority rank of a subject terminal if the propagation quality between the base station apparatus 110 and the antenna device 130 is relatively higher than the propagation quality between the base station apparatus 110 and the subject terminal, thereby enhancing the possibility that a subject terminal having an improving propagation quality will be given allocation of the wireless resources after other communication terminals, extending the period of time before the subject terminal having an improving propagation quality starts to communicate. Thus, communication with the subject terminal may be performed after the propagation quality for the subject terminal has improved.

The control unit 511 controls reception of the data at the data receiver unit 503, based on results of the scheduling by the scheduler unit 512. The control unit 511 controls transmission of the data at the data transmitter unit 517, based on the results of the scheduling by the scheduler unit 512. The control unit 511 outputs the results of the scheduling by the scheduler unit 512 to the data transmitter unit 517.

Under the control of the control unit 511, the sync signal transmitter unit 513 generates the sync signal for the antenna device 130 and the terminal devices 141 to 143 to synchronize with the base station apparatus 110. The sync signal generated by the sync signal transmitter unit 513 is further used as the reference signal for measuring the downlink propagation quality, in the antenna device 130 and the terminal devices 141 to 143. The sync signal transmitter unit 513 outputs the generated sync signal to the transmitter 518.

The signaling transmitter unit 514 generates the signaling signal to be transmitted to the antenna device 130 and the terminal devices 141 to 143 and outputs the generated signaling signal to the transmitter 518. The signaling signal generated by the signaling transmitter unit 514 includes the results of the allocation of the reference signal reported by the control unit 511 and the results of the scheduling output from the control unit 511.

The external input unit 515 receives input of data (user data) transmitted from the external core network. The external input unit 515 outputs the received data to the transmitting buffer 516. The transmitting buffer 516 stores the data output from the external input unit 515. Under the control of the control unit 511, the data transmitter unit 517 reads out the data stored to the transmitting buffer 516 and generates data to be transmitted to the terminal devices 141 to 143. The data transmitter unit 517 outputs the generated data to the transmitter 518.

The transmitter 518 converts the sync signal from the sync signal transmitter unit 513, the signaling signal from the signaling transmitter unit 514, and the data from the data transmitter unit 517 to an analog signal. The transmitter 518 up-converts the analog signal (baseband signal) to an RF signal and outputs the RF signal to the duplexer 501.

The data receiver unit 503, the signaling receiver unit 506, the identification information extractor unit 507, the feedback receiver unit 508, the propagation quality measurement unit 509, the fluctuation analysis unit 510, the control unit 511, the scheduler unit 512, the sync signal transmitter unit 513, the signaling transmitter unit 514, and the data transmitter unit 517 may be implemented, for example, by an arithmetic device such as a DSP.

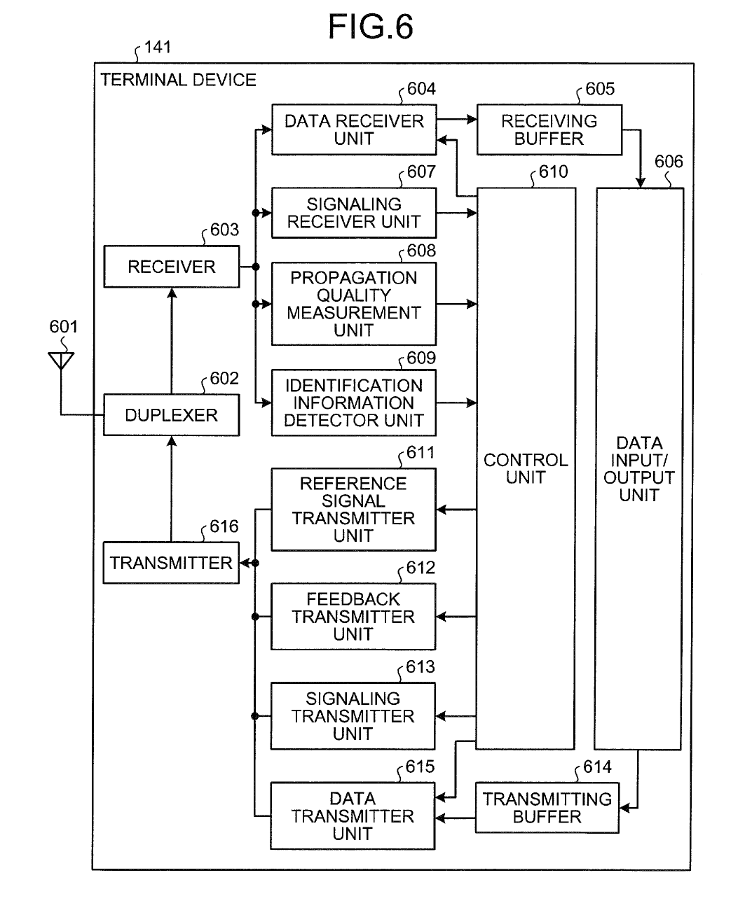

FIG. 6 depicts a configuration of the terminal device according to the first embodiment. Although FIG. 6 describes a configuration of the terminal device 141, among the terminal devices 141 to 143, the terminal devices 142 and 143 have a substantially identical configuration. As depicted in FIG. 6, the terminal device 141 is equipped with an antenna 601, a duplexer 602, a receiver 603, a data receiver unit 604, a receiving buffer 605, a data input/output unit 606, a signaling receiver unit 607, a propagation quality measurement unit 608, an identification information detector unit 609, a control unit 610, a reference signal transmitter unit 611, a feedback transmitter unit 612, a signaling transmitter unit 613, a transmitting buffer 614, a data transmitter unit 615, and a transmitter 616.

The antenna 601 is an antenna for performing the wireless communication with the base station apparatus 110 and the antenna device 130. The antenna 601 receives signals transmitted from the base station apparatus 110 or the antenna device 130 and outputs each received signal to the duplexer 602. The antenna 601 transmits to the base station apparatus 110, the signal output from the duplexer 602. While the antenna 601 is an antenna having functions of a transmitting antenna and a receiving antenna, a transmitting antenna and a receiving antenna may separately be provided in place of the antenna 601.

The duplexer 602 outputs to the receiver 603, the signal from the antenna 601. The duplexer 602 outputs to the antenna 601, the signal from the transmitter 616. If the transmitting antenna and the receiving antenna are separately provided in place of the antenna 601, the duplexer 602 may be omitted.

The receiver 603 down-converts the signal (RF signal) output from the duplexer 602 to a baseband signal and then converts the baseband signal to a digital signal. The receiver 603 outputs the digital signal to the data receiver unit 604, the signaling receiver unit 607, the propagation quality measurement unit 608, and the identification information detector unit 609.

Under the control of the control unit 610, the data receiver unit 604 receives the data (user data) transmitted by the base station apparatus 110, among the signals output from the receiver 603. The data receiver unit 604 outputs the received data to the receiving buffer 605. The receiving buffer 605 stores the data output from the data receiver unit 604.

The data input/output unit 606 is connected to a user interface, such as a display, a speaker, a keyboard, a microphone, etc., provided in the terminal device 141. The data input/output unit 606 reads out the data stored to the receiving buffer 605 and outputs the read-out data to the user by way of the user interface. The data input/output unit 606 outputs to the transmitting buffer 614, the data input by way of the user interface.

The signaling receiver unit 607 receives the signaling signal transmitted by the base station apparatus 110, among the signals output from the receiver 603. The signaling signal includes the number of the reference signal allocated to the terminal device 141 by the base station apparatus 110. The signaling receiver unit 607 outputs the received number of the reference signal to the control unit 610. The signaling signal includes the results of the scheduling of the terminal device 141 performed by the base station apparatus 110. The signaling receiver unit 607 outputs the received results of the scheduling to the control unit 610.

The propagation quality measurement unit 608 receives the reference signal transmitted by the base station apparatus 110, among the signals output from the receiver 603. The propagation quality measurement unit 608 measures the downlink propagation quality, based on the received reference signal. The propagation quality measurement unit 608 notifies the control unit 610 of the measured propagation quality.

The identification information detector unit 609 detects the identification information transmitted by the antenna device 130, among the signals output from the receiver 603. The identification information detector unit 609 outputs the detected identification information to the control unit 610. The identification information from the antenna device 130 is broadcast inside the open space 122 of the mobile object 120 and the terminal device 141 receives the identification information by, for example, suspending reception of the signal from the base station apparatus 110. Since it is sufficient for the identification information to be received at least once, the terminal device 141 may receive the identification information intermittently, over a long cycle.

The control unit 610 performs the communication control of the terminal device 141. For example, the control unit 610 controls the reception of the data in the data receiver unit 604, based on the results of the scheduling output from the signaling receiver unit 607. The control unit 610 outputs to the reference signal transmitter unit 611, the number of the reference signal output from the signaling receiver unit 607. The control unit 610 notifies the feedback transmitter unit 612 of the propagation quality reported by the propagation quality measurement unit 608.

The control unit 610 outputs to the signaling transmitter unit 613, the identification information from the identification information detector unit 609. The control unit 610 controls the signaling transmitter unit 613 so as to generate a signaling signal inclusive of a request to the base station apparatus 110 for the allocation of a reference signal. The control unit 610 controls the transmission of the data in the data transmitter unit 615, based on the results of the scheduling output from the signaling receiver unit 607.

The reference signal transmitter unit 611 generates a reference signal, based on the number of the reference signal output from the control unit 610 and outputs the generated reference signal to the transmitter 616. The feedback transmitter unit 612 generates feedback information indicative of the propagation quality reported by the control unit 610 and outputs the generated feedback information to the transmitter 616.

The signaling transmitter unit 613 generates a signaling signal inclusive of the identification information output from the control unit 610. Under the control of the control unit 610, the signaling transmitter unit 613 generates a signaling signal inclusive of a request for allocation of a reference signal. The signaling transmitter unit 613 outputs the generated signaling signal to the transmitter 616.

The transmitting buffer 614 stores the data output from the data input/output unit 606. Under the control of the control unit 610, the data transmitter unit 615 reads out the data stored to the transmitting buffer 614 and generates data to be transmitted to the base station apparatus 110. The data transmitter unit 615 outputs the generated data to the transmitter 616.

The transmitter 616 converts the reference signal from the reference signal transmitter unit 611, the feedback information from the feedback transmitter unit 612, the signaling signal from the signaling transmitter unit 613, and the data from the data transmitter unit 615 to an analog signal. The transmitter 616 up-converts the analog signal (baseband signal) to an RF signal and outputs the RF signal to the duplexer 602.

The data receiver unit 604, the receiving buffer 605, the signaling receiver unit 607, the propagation quality measurement unit 608, the identification information detector unit 609, the control unit 610, the reference signal transmitter unit 611, the feedback transmitter unit 612, the signaling transmitter unit 613, and the data transmitter unit 615 may be implemented, for example, by an arithmetic device such as a DSP.

In this way, in the communication system 100 according to the first embodiment, the use of the antenna device 130 provided at a forward aspect of the mobile object 120 enable forecast of the fluctuation of the propagation quality at the terminal devices 141 to 143 in the mobile object 120. The scheduling performed based on the results of the forecast of the propagation quality fluctuation enhances the communication quality (throughput) between the base station apparatus 110 and the terminal devices 141 to 143.

For example, the communication is performed with the wireless resources allocated to the terminal devices 141 to 143 under a better state of propagation quality, by adjusting the priority rank of the terminal devices 141 to 143, based on the results of the forecast of the propagation quality fluctuation. This communication system may be implemented without using the propagation environment information, etc., correlated with the map information for the forecast of the propagation quality. This communication system may be implemented without making a major specification change, for example, to the terminal devices 141 to 143.

A basic configuration of the communication system 100 according to a second embodiment is substantially identical to the configuration depicted in FIG. 1, with the exception that the antenna device 130 receives the reference signal from the base station apparatus 110 by the forecast-use antenna 131 and that the antenna device 130 measures the propagation quality, based on the received reference signal and transmits the feedback information indicative of the measured propagation quality to the base station apparatus 110 by the forecast-use antenna 131.

The antenna device 130, using the terminal-use antenna 132, distributes to the terminal devices 141 to 143, the identification information (e.g., feedback channel) indicative of the feedback information to be transmitted from the forecast-use antenna 131. The terminal devices 141 to 143 receive the reference signal from the base station apparatus 110, measure the propagation quality based on the received reference signal, and transmit feedback information indicative of the measured propagation quality to the base station apparatus 110. The configuration of the terminal devices 141 to 143 according to the second embodiment is substantially identical to the configuration depicted in FIG. 6.

The base station apparatus 110 compares the propagation quality indicated by the feedback information from the antenna device 130 and the propagation quality indicated by the feedback information from the terminal devices 141 to 143 and performs the scheduling based on the results of the comparison. The base station apparatus 110 identifies the feedback information transmitted from the antenna device 130, from among feedback information transmitted from other sources in the vicinity, based on the identification information transmitted from the terminal devices 141 to 143.

The feedback information to be transmitted to the base station apparatus 110 from the antenna device 130 and the terminal devices 141 to 143 is signals multiplexed by time, frequency, or code etc. With different feedback channels allocated for the antenna device 130 and the terminal devices 141 to 143, the feedback information from the antenna device 130 and the terminal devices 141 to 143 may be multiplexed for transmission to the base station apparatus 110.

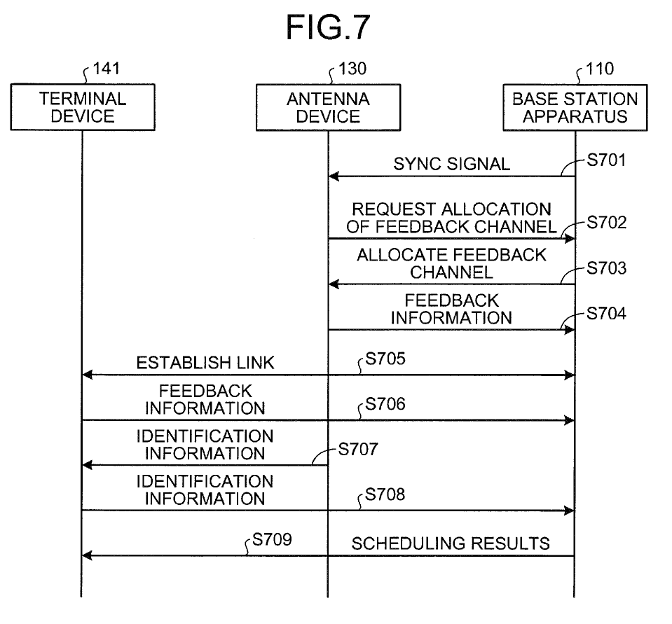

FIG. 7 is a sequence diagram of one example of operation of the communication system according to the second embodiment. Although FIG. 7 describes the operation of the terminal device 141, among the terminal devices 141 to 143, the operation of the terminal devices 142 and 143 is substantially identical. The operation at step S701 is substantially identical to that at step S201 depicted in FIG. 2. After step S701, the antenna device 130 requests the base station apparatus 110 for allocation of a feedback channel (step S702). The request for the allocation of the feedback channel at step S702 is made using, for example, an uplink random access channel, etc.

In response to the request for the allocation at step S702, the base station apparatus 110 allocates a feedback channel to the antenna device 130 (step S703). Subsequently, the antenna device 130, using the feedback channel allocated at step S703, starts to transmit feedback information indicative of the propagation quality for the base station apparatus 110 (step S704).

Then, the terminal device 141 in the mobile object 120 establishes a link, by initial access or handover, etc., with the base station apparatus 110 (step S705). With the link established at step S705, the terminal device 141 is allocated a feedback channel by the base station apparatus 110.

Then, the terminal device 141, using the feedback channel allocated by the base station apparatus 110, starts to transmit feedback information indicative of the propagation quality with the base station apparatus 110 (step S706).

Then, the antenna device 130 distributes the identification information of the feedback information that the antenna device 130 has started to transmit at step S704 (step S707). The identification information distributed at step S707 is received by the terminal device 141 located in the open space 122 of the mobile object 120. The terminal device 141 transmits the identification information distributed at step S707 to the base station apparatus 110 (step S708).

Subsequently, the base station apparatus 110 performs the scheduling based on the feedback information, the transmission of which commencing at step S704 and step S706, and notifies the terminal device 141 of results of the scheduling (step S709), ending a sequence of operations.

These steps enable the base station apparatus 110 to perform the scheduling of the terminal device 141, based on the propagation quality between the base station apparatus 110 and the antenna device 130 and the propagation quality between the base station apparatus 110 and the terminal device 141. Although an example has been described of the base station apparatus 110 allocating the feedback channel by which the antenna device 130 transmits, the feedback channel used by the antenna device 130 may be preliminarily determined. In this case, there is no need for the allocation of the feedback channel by the base station apparatus 110.

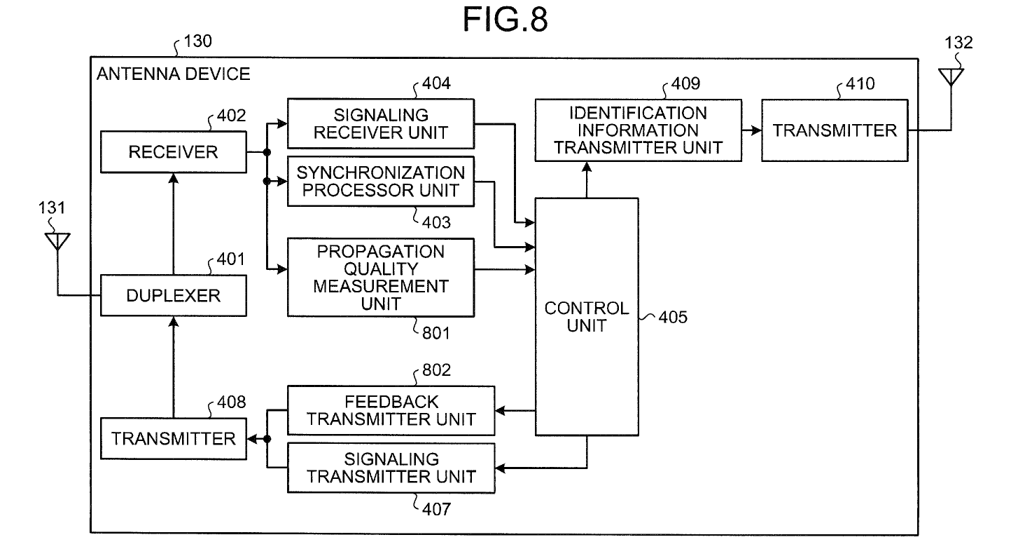

FIG. 8 depicts one example of a configuration of the antenna device according to the second embodiment. In FIG. 8, components identical to those depicted in FIG. 4 are given same reference numerals used in FIG. 4 and description thereof is omitted. As depicted in FIG. 8, the antenna device 130 according to the second embodiment is equipped with a propagation quality measurement unit 801 and a feedback transmitter unit 802 in addition to the configuration depicted in FIG. 4. The signaling receiver unit 404 receives the number of the feedback channel allocated by the base station apparatus 110, among the signals output from the receiver 402. The signaling receiver unit 404 outputs the received number of the feedback channel to the control unit 405.

The propagation quality measurement unit 801 receives the reference signal transmitted from the base station apparatus 110, among the signals output from the receiver 402. The propagation quality measurement unit 801 measures the propagation quality between the antenna device 130 and the base station apparatus 110, based on the received reference signal and notifies the control unit 405 of the measured propagation quality.

The control unit 405 controls the signaling transmitter unit 404 so as to generate, based on the basic information output from the synchronization processor unit 403, a signaling signal requesting the base station apparatus 110 for a feedback channel. The control unit 405 notifies the feedback transmitter unit 802 of the number of the feedback channel output from the signaling receiver unit 404 and the propagation quality reported by the propagation quality measurement unit 801.

Under the control of the control unit 405, the signaling transmitter unit 407 generates the signaling signal requesting the base station apparatus 110 for a feedback channel. The signaling transmitter unit 407 outputs the generated signaling signal to the transmitter 408. The feedback transmitter unit 802 generates feedback information indicative of the propagation quality reported by the control unit 405, based on the number of the feedback channel reported by the control unit 405. The feedback transmitter unit 802 outputs the generated feedback information to the transmitter 408.

The transmitter 408 converts the feedback information output from the feedback transmitter unit 802 to an analog signal, up-converts the analog signal (baseband signal) to an RF signal, and outputs the RF signal to the duplexer 401. Thus, the antenna device 130 is able to measure the propagation quality, based on the reference signal from the base station apparatus 110 and transmit feedback information indicative of the measured propagation quality to the base station apparatus 110.

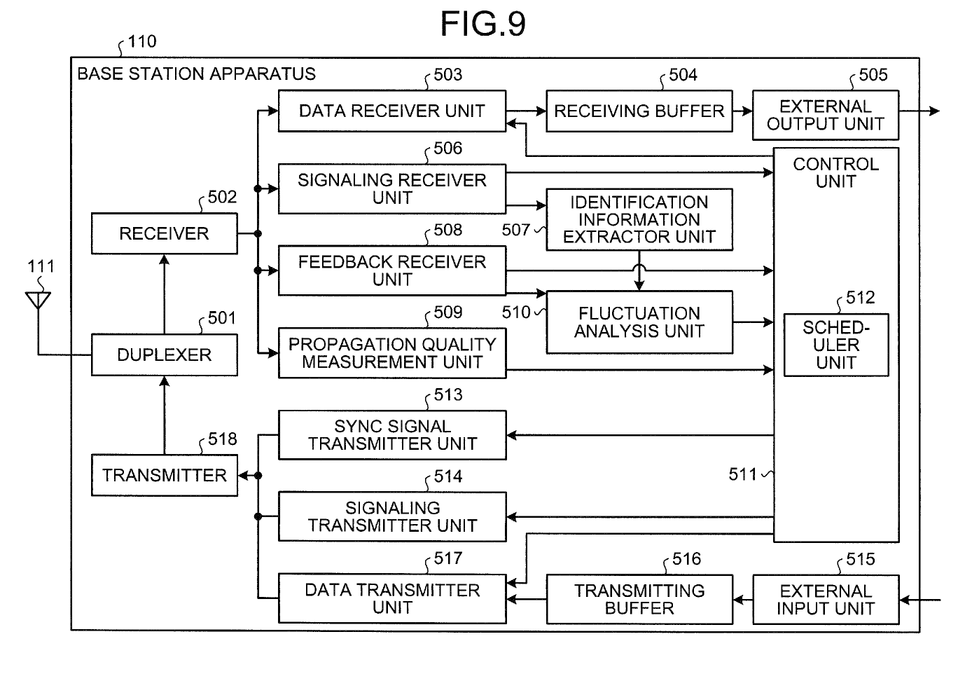

FIG. 9 depicts one example of a configuration of the base station apparatus according to the second embodiment. In FIG. 9, components substantially identical to those depicted in FIG. 5 are given the same reference numerals used in FIG. 5 and description thereof is omitted. As depicted in FIG. 9, the feedback receiver unit 508 of the base station apparatus 110 according to the second embodiment outputs the received feedback information to the fluctuation analysis unit 510 and the control unit 511. In the base station apparatus 110 according to the second embodiment, the propagation quality measurement unit 509 needs not notify the fluctuation analysis unit 510 of the measured propagation quality.

The fluctuation analysis unit 510 compares the propagation quality between the antenna device 130 and the base station apparatus 110 and the propagation quality between the base station apparatus 110 and the terminal devices 141 to 143 by means of the propagation quality indicated by the feedback information output from the feedback receiver unit 508. The fluctuation analysis unit 510 is capable of identifying the feedback information from the antenna device 130 from among feedback information reported by the feedback receiver unit 508, based on the identification information output from the identification information extractor unit 507.

Thus, in the communication system 100 according to the second embodiment, the use of the feedback information from the antenna device 130 and the terminal devices 141 to 143 makes it possible to forecast at the base station apparatus 110, the fluctuation of the propagation quality at the terminal devices 141 to 143. Consequently, the second embodiment achieves the same effect as that of the first embodiment.

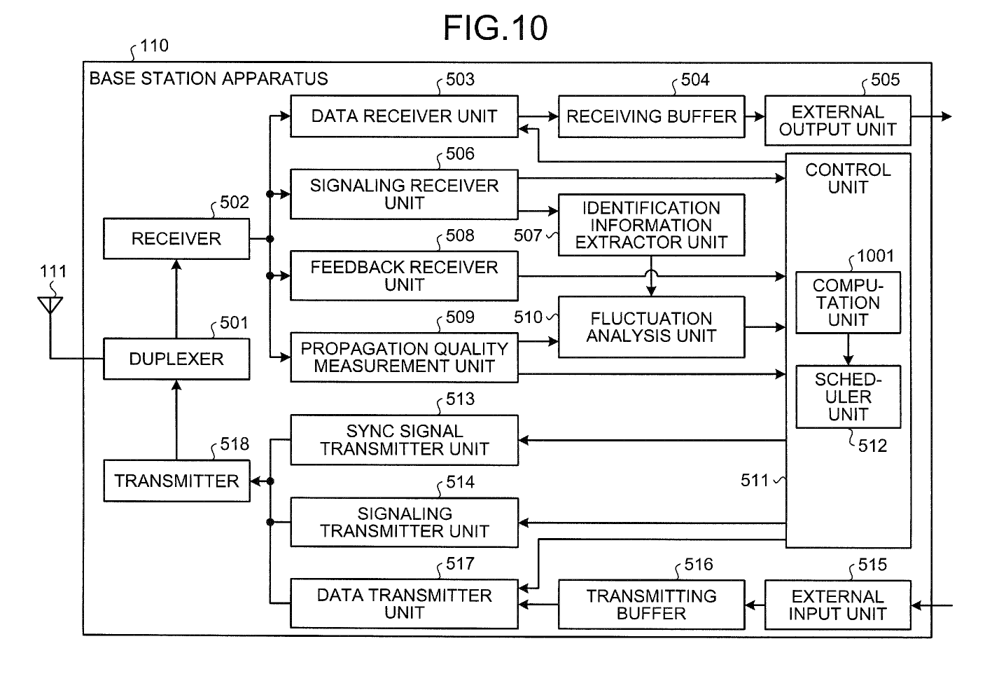

FIG. 10 depicts one example of a configuration of the base station apparatus according to a third embodiment. In FIG. 10, components substantially identical to those depicted in FIG. 5 are given same reference numerals and description thereof is omitted. As depicted in FIG. 10, the control unit 511 of the base station apparatus 110 according to the third embodiment is equipped with a computation unit 1001 in addition to the scheduler unit 512 depicted in FIG. 5. The computation unit 1001 acquires the propagation quality reported by the propagation quality measurement unit 509.

The computation unit 1001 computes the time lag between the fluctuation of the propagation quality between the antenna device 130 and the base station apparatus 110 and the fluctuation of the propagation quality between the base station apparatus 110 and the terminal devices 141 to 143, based on the acquired propagation quality. That is to say, the time lag computed by the computation unit 1001 is the time from a change in the propagation quality between the antenna device 130 and the base station apparatus 110 until a subsequent change in the propagation quality between the base station apparatus 110 and the terminal devices 141 to 143.

Here, one example will be described of a method of calculating the time lag by the computation unit 1001. The propagation quality (here, considered as field strength) of the antenna device 130 at time tᵢ is given as Po(tᵢ) and the field strength of the terminal devices 141 to 143 at time tᵢ is given as Pm(tᵢ). In this case, the correlation coefficient Δ of the field strength of antenna device 130 and the field strength of the terminal devices 141 to 143 at time lag τ may be computed, for example, by equation (1).

$$Δ = 〈 {\vert \frac{{P}_{m} ( {t}_{i} + τ )}{〈 {p}_{m} ( {t}_{i} ) 〉} - \frac{{P}_{0} ( {t}_{i} )}{〈 {p}_{0} ( {t}_{i} ) 〉} \vert}^{2} 〉 \qquad ( 1 )$$

In equation (1), < > represents an averaging calculation. Equation (1) indicates that the smaller the correlation coefficient Δ is, the higher the fluctuation correlation of the field strength of the antenna device 130 and the field strength of the terminal devices 141 to 143 is. Equation (1) allows the computation unit 1001 to compute the time lag τ at which the correlation of these field strengths is highest, by calculating the correlation coefficient Δ while varying the time lag τ to obtain the time lag τ at which the correlation coefficient Δ is smallest. The computation unit 1001 notifies the scheduler unit 512 of the computed time lag.

The scheduler unit 512 changes the amount of adjustment in priority rank, based on the fluctuation forecast (see, e.g., steps S305 and S307 of FIG. 3) according to the time lag reported by the computation unit 1001. For example, the scheduler unit 512 has a threshold pre-established. The scheduler unit 512 compares the time lag reported by the computation unit 1001 and the threshold with respect to each of the terminal devices 141 to 143 and makes the amount of adjustment in priority rank greater for a terminal device having a time lag below the threshold as compared with a terminal device having a time lag at or above the threshold.

Here, it is assumed, for example, that the terminal device 141 is located close to the antenna device 130 (at the forward aspect of the mobile object 120) and that the terminal device 143 is located far from the antenna device 130 (at the rear aspect of the mobile object 120). It is also assumed that the time lag reported by the computation unit 1001 is below the threshold with respect to the terminal device 141 and that the time lag reported by the computation unit 1001 is at or above the threshold with respect to the terminal device 143. In this case, the amount of adjustment in priority rank for the terminal device 141 is greater than the amount of adjustment of the priority rank for the terminal device 143.

The scheduler unit 512 may, with respect to the terminal devices 141 to 143, make the amount of adjustment greater for a terminal device having a smaller time lag reported by the computation unit 1001. Here, it is assumed that the terminal device 141 is located close to the antenna device 130 and that the terminal device 143 is located far from the antenna device 130. In this case as well, since the time lag of the terminal device 141 is smaller than that of the terminal device 143, the amount of adjustment in priority rank for the terminal device 141 is greater than the amount of adjustment for the terminal device 143.

Therefore, for example, at the time of the mobile object 120 entering a tunnel, if the propagation quality for the terminal devices 141 to 143 is deteriorating, the priority rank of the terminal device 141 becomes higher, with a greater amount of adjustment, than that of the terminal device 143 (see, e.g., steps S305 and S307 of FIG. 3). This makes the priority rank of the terminal device 141 prone to be higher than that of the terminal device 143. For this reason, the wireless resources may be allocated preferentially to the terminal device 141 whose propagation quality deteriorates before that of the terminal device 143. The computation unit 1001 may be implemented, for example, by an arithmetic device such as a DSP.

Thus, the communication system 100 according to the third embodiment is capable of compensating for differences in the timing of the propagation quality fluctuations consequent to the position of the terminal devices 141 to 143 in the mobile object 120 by changing the amount of adjustment in priority rank according to the time lag computed by the computation unit 1001. Therefore, the third embodiment has the same effect as that of the first embodiment and is capable of performing unbiased scheduling irrespective of the position of the terminal devices 141 to 143 in the mobile object 120.

Here, an example has been described of achieving the third embodiment by providing the computation unit 1001 in the scheduler unit 512 (see FIG. 5) of the base station apparatus 110 according to the first embodiment. By contrast, configuration may be so as to achieve the third embodiment by providing the computation unit 1001 in the scheduler unit 512 (see FIG. 9) of the base station apparatus 110 according to the second embodiment.

As described above, according to the base station apparatus, the antenna device, the terminal device, the communication system, and the communication method, the use of the antenna device provided at the forward aspect of the mobile object makes it possible to accurately forecast fluctuations in the propagation quality for the terminal device in the mobile object, thereby enhancing communication quality.

In the embodiments described above, although the example has been described of using the field strength as the propagation quality, the propagation quality is not limited to field strength and may be Signal to Interference and Noise Ratio (SIRN) or error rate.

The disclosed base station apparatus, antenna device, terminal device, communication system, and communication method enhance communication quality.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station apparatus that communicates with a terminal device, the base station comprising:
an acquiring unit that acquires propagation quality between the base station apparatus and the terminal device and propagation quality between the base station apparatus and an antenna device provided forward of the terminal device; and
a scheduler unit that allocates wireless resources for communication with the terminal device, based on the propagation qualities acquired by the acquiring unit.

2. The base station apparatus according to claim 1, wherein
the acquiring unit acquires the propagation qualities by measurement based on reference signals transmitted from the terminal device and the antenna device.

3. The base station apparatus according to claim 2, comprising:
a receiver unit that receives from the terminal device, identification information indicative of the reference signal to be transmitted from the antenna device, wherein
the acquiring unit performs the measurement based on the reference signal indicated by the identification information received by the receiver unit.

4. The base station apparatus according to claim 1, comprising:
a transmitter unit that transmits a reference signal, wherein
the acquiring unit acquires via feedback information from the terminal device and the antenna device, the propagation qualities measured based on the reference signal by the terminal device and the antenna device.

5. The base station apparatus according to claim 4, comprising:
a receiver unit that receives from the terminal device, identification information indicative of the feedback information to be transmitted from the antenna device, wherein
the acquiring unit acquires the feedback information indicated by the identification information received by the receiver unit.

6. The base station apparatus according to claim 1, wherein
the scheduler unit allocates the wireless resources to plural communication terminals, including the terminal device, in descending order of priority and adjusts the priority of the terminal device, based on the propagation qualities.

7. The base station apparatus according to claim 6, wherein
the scheduler unit raises the priority of the terminal device if the propagation quality between the base station apparatus and the antenna device is lower than the propagation quality between the base station apparatus and the terminal device.

8. The base station apparatus according to claim 6, wherein
the scheduler unit reduces the priority of the terminal device if the propagation quality between the base station apparatus and the antenna device is higher than the propagation quality between the base station apparatus and the terminal device.

9. The base station apparatus according to claim 6, comprising:
a computation unit that computes a time lag between a fluctuation in the propagation quality between the base station apparatus and the antenna device and a fluctuation in the propagation quality between the base station apparatus and the terminal device, wherein
the scheduler unit changes the amount of adjustment in priority rank according to the time lag computed by the computation unit.

10. The base station apparatus according to claim 9, wherein
the scheduler unit makes the amount of adjustment for a terminal device having a time lag that is below a threshold greater than the amount of adjustment for a terminal device having a time lag at or above the threshold.

11. The base station apparatus according to claim 9, wherein
the scheduler unit makes the amount of adjustment in priority rank greater for a terminal device having a smaller time lag computed by the computation unit.

12. A terminal device that communicates with a base station apparatus and is carried by a mobile object having an antenna device provided forward of the terminal device, the terminal device comprising:
a receiver unit that receives from the antenna device identification information of a reference signal to be transmitted from the antenna device to the base station apparatus;
a first transmitter unit that transmits to the base station apparatus, the identification information received by the receiver unit; and
a second transmitter unit that transmits to the base station apparatus, the reference signal.

13. A communication system comprising:
a terminal device on a mobile object;
an antenna device provided forward of the terminal device, on the mobile object; and
a base station apparatus that allocates wireless resources for communication with the terminal device, based on propagation quality between the base station apparatus and the terminal device and the propagation quality between the base station apparatus and the antenna device.

14. A communication method of performing communication between a base station apparatus and a terminal device on a mobile object, the communication method comprising:
measuring a first propagation quality between the base station apparatus and an antenna device provided forward of the terminal device, on the mobile object;
measuring a second propagation quality between the terminal device and the base station apparatus; and allocating wireless resources for the communication between the base station apparatus and the terminal device, based on the first propagation quality and the second propagation quality.
